(19) United States
(12) Patent Application Publication
(10) Pub. No.: US 2015/0045943 A1
(43) Pub. Date: Feb. 12, 2015

(54) Warehouse Control System With Dynamic Process Control

(71) Applicant: Intelligrated Headquarters LLC, Mason, OH (US)

(72) Inventor: Daniel Raymond Napoli, Bedford Corners, NY (US)

(73) Assignee: Intelligrated Headquarters LLC, Mason, OH (US)

(21) Appl. No.: 14/186,090

(22) Filed: Feb. 21, 2014

Related U.S. Application Data
(60) Provisional application No. 61/864,587, filed on Aug. 11, 2013.
(60) Provisional application No. 61/928,192, filed on Jan. 16, 2014.

(51) Int. Cl. G06Q 10/06; G06Q 30/02; G06Q 20/10; B65G 43/00

(52) U.S. Cl. CPC G06Q 10/06311; B65G 43/00; G06Q 30/0206; G06Q 20/10
USPC 700/214; 705/7.13

(57) ABSTRACT

Systems, methods, devices, and non-transitory processor readable storage media of the various embodiments enable warehouse control system automated processes to be dynamically created and changed by users. In the various embodiments, warehouse control system automated processes may be table based. In an embodiment, a user may download additional automated processes tables to add new automated processes to a warehouse control system. In another embodiment, a user may select the order and/or make-up of tasks forming the sub-processes of an automated process table.

### CROSS REFERENCE TO RELATED APPLICATIONS

This application claims the benefit of priority to U.S. Provisional Patent Application No. 61/864,587 entitled “Fulfillment Execution Systems, Methods, and Devices” filed Aug. 11, 2013, and to U.S. Provisional Patent Application No. 61/928,192 entitled “Warehouse Control System with Dynamic Process Control” filed Jan. 16, 2014. The entire contents of both applications are hereby incorporated by reference.

### BACKGROUND

Traditional warehouse control systems provide users (e.g., customers purchasing a warehouse control system) with automated processes to control warehouse tasks, such as picking, packing, and shipping of items to fill orders. In traditional warehouse control systems the automated processes are provided as a series of static hard coded routines. Typically, the user has no control over the order or make up of any sub-tasks forming any of the automated processes. In traditional warehouse control systems, users may select or de-select an automated process to apply to an item from the set of automated processes pre-provisioned into the user's local warehouse control system, but adding new automated processes or changing the sub-tasks forming any automated process is time intensive and labor intensive requiring extensive changes to the hard coded routines of the user's local warehouse control system.

In traditional warehouse control systems when a user desires a new automated process or change to sub-tasks forming any automated process, the user must propose the change(s) and engineers must conduct studies, such as labor, time, and/or return on investment studies, to determine whether the new automated process or change to a sub-task is feasible to implement in the user's warehouse. After the completion of the studies, an information technology vendor must rewrite or add to the static hard coded routines in the user's local warehouse control system. Once the static hard coded routines are updated and/or added to, only then may the new automated process or change to the sub-tasks be implemented, actually used and validated in the warehouse. Thus, the traditional warehouse control systems are slow to respond to changing user needs. In addition, traditional warehouse control systems require extensive cost and labor outlays to meet new user requirements.

### SUMMARY

The systems, methods, devices, and non-transitory processor readable storage media of the various embodiments enable warehouse control system automated processes to be dynamically created and changed by users. In the various embodiments, warehouse control system automated processes may be table based. In an embodiment, a user may download additional automated processes tables to add new automated processes to a warehouse control system. In another embodiment, a user may select the order and/or make-up of tasks forming an automated process.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a system block diagram of a network suitable for use with the various embodiments.

FIG. 2 is a block diagram of modules of a warehouse control system module according to an embodiment.

FIG. 3 is a process flow diagram illustrating an embodiment method for customers to dynamically create and change automated process tables for use in a warehouse control system.

FIG. 4 is a process flow diagram illustrating an embodiment method for processing assigned tasks using automated process tables and nested loops of process control logic.

FIG. 5 illustrates an example screen shot of a portal enabling customers to create automated processes according to an embodiment.

FIG. 6 is a component diagram of an example computing device suitable for use with the various embodiments.

FIG. 7 is a component diagram of an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the term “computing device” is used to refer to any one or all of desktop computers, personal data assistants (PDA's), laptop computers, tablet computers, smart books, palm-top computers, and similar electronic devices which include a programmable processor and memory and circuitry configured to provide the functionality described herein.

The various embodiments are described herein using the term “server.” The term “server” is used to refer to any computing device capable of functioning as a server, such as a master exchange server, web server, mail server, document server, or any other type of server. A server may be a dedicated computing device or a computing device including a server module (e.g., running an application which may cause the computing device to operate as a server). A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as laptop computer, thereby enabling it to function as a server (e.g., an enterprise e-mail server) only to the extent necessary to provide the functionality described herein.

The systems, methods, devices and non-transitory processor readable storage media of the various embodiments enable warehouse control system automated processes to be dynamically created and modified by users (e.g., customers purchasing a warehouse control system). In the various embodiments, warehouse control system automated processes may be table based. A customer's warehouse control system may be configured with a process control engine and one or more process table. The process tables may be comprises of sub-tasks that control how assigned tasks, such as orders, cycle counts, item moves, location/item replenishments, etc., and/or items associated with the assigned tasks, such as items within orders, items to be moved, items to be reordered, etc., are handled by the warehouse control system to control warehouse tasks, such as picking, packing, and shipping of items to fill orders.

In an embodiment, a process control engine may select one or more process table to execute using nested loops of process control logic. As an example, an outer loop of control logic may be applied by the process control engine to select one or more appropriate process table used to handle an assigned task, such as an order, cycle count, item move, location/item replenishment, etc., when the assigned task is received. The process control engine may also apply an inner loop of control logic to select one or more appropriate process table used to handle (e.g., ship, move, count, etc.) items included in the received assigned task, such as an order, cycle count, item move, location/item replenishment, etc. The nested loops may be executed sequentially with outer loop processes executed when an assigned task is received, inner loop processes continue to execute until handling of the items associated with the assigned task is complete. Once the handling of the items on the assigned order is complete (e.g., shipment of items on an order is complete, movement of items on an item movement request is complete, a cycle count is complete, an item reorder is complete), the process control engine may execute after loop processes before returning to the outer loop to handle the next assigned task (e.g., the next order, cycle count, item move, location/item replenishment, etc.). After loop processes may include processes performed prior to handling a next assigned task, such as displaying labor standards, displaying performance metrics, displaying associated staging locations, requesting verification of successful sub-task execution (e.g., verifying palletization of items for shipment), etc. Process tables may be segregated into outer loop process tables and inner loop process tables based on whether the sub-tasks of the process table are executed by the outer loop control logic or inner loop control logic.

The use of table based processes may enable simplified modification of the handling of assigned tasks, such as handling of orders and/or the shipping of items, cycle counts, item moves, location/item replenishments, etc., by the warehouse control system by replacing and/or updating a process table. Such modification may be made without requiring changes to the process control engine. By merely replacing and/or updating a process table, a new automated process may be implemented quickly and without requiring extensive changes to the hard coded routines of the customer's warehouse control system. In this manner, users may select new processes and try the new processes in their warehouse without waiting for engineering studies, return on investment analysis, or other labor intensive processes. Thus, new processes may be validated as they are implemented and warehouse control system processes may be dynamically changed as customer requirements change.

In an embodiment, a user may download additional automated processes tables to add new automated processes to a warehouse control system. In another embodiment, a user may select the order and/or make-up of tasks forming an automated process. In an embodiment, a warehouse control system provider (e.g., a seller of warehouse control systems) may host a web based portal (e.g., a website) at which additional automated process tables may be made available to customers. The web based portal may operate as an application library providing indications of pre-built automated processes and/or sub-tasks. In an embodiment, users may select from the pre-built automated processes and/or sub-tasks to create new automated processes tables. These new automated process tables may be downloaded into the customer's warehouse control system. In this manner, customized applications or process may be selected by a user to upgrade their warehouse control system. As an example, a warehouse control system seller's website may include a list of pre-built sub-tasks that may be selected by a user. The user may drag and drop sub-tasks from the list into a new process field. By dragging and dropping sub-tasks, embodiments may generate a listing of sub-tasks to be included in a new process table. The user may select an upload button to send the new process table to the customer's warehouse control system. The warehouse control system seller may generate the new process table and download it to the user's warehouse control system. Once downloaded, the process control engine of the user's warehouse control system may then use the new process table to handle assigned tasks, such as an order.

In an embodiment, a cost associated with a selected pre-built process and/or sub-task may be determined by the warehouse control system seller. In addition, an indication of the determined cost and payment request may be generated for the user. Once the seller determines a payment equal to the determined cost is received in response to the payment request, the seller may then generate the new process table and download it to the user's warehouse control system.

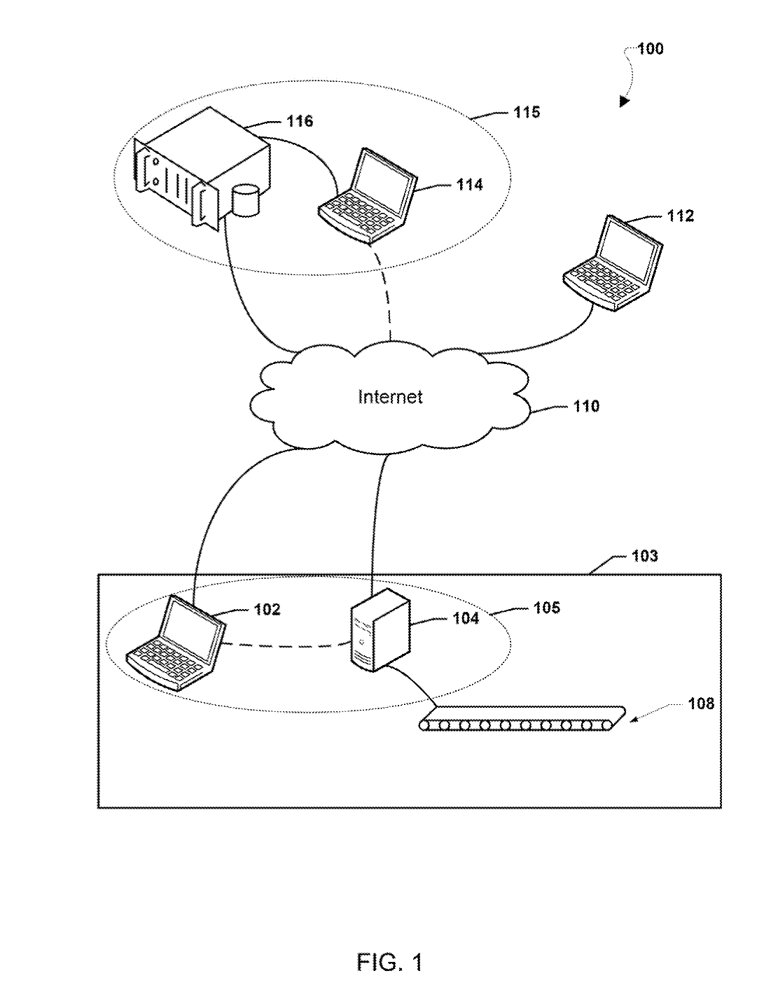

FIG. 1 illustrates a network 100 suitable for use with the various embodiments. The network 100 may include one or more warehouse control system 105 controlling operations in one or more warehouse 103 and one or more warehouse control system seller system 115. The warehouse control system 105 may comprise multiple computing devices, such as a user terminal 102 and warehouse control computer 104. The user terminal 102 and the warehouse control computer 104 may be connected to the Internet 110 and/or optionally may be directly connected via a local network connection. In this manner, via the connections to the Internet 110 and/or the local network connection, the user terminal 102 and warehouse control computer 104 may exchange data. The warehouse control computer 104 may be connected to warehouse handling equipment 108, such as conveyors, sorters, pick to light systems, etc., and the warehouse control computer 104 may generate instructions to control the warehouse handling equipment 108 to enable inventory items in the warehouse 103 to be handled in response to assigned task, for example, moved within the warehouse 103 in response to item moves, counted in response to cycle counts, shipped from the warehouse 103 in response to received orders, etc. The user terminal 102 may enable a user to monitor the status of the warehouse control system 105, manage the handling of assigned task and items, and interface with the warehouse control system seller system 115 via the Internet 110. A warehouse control system module including a process control engine and one or more process table may run on a processor of the user terminal 102 and/or the warehouse control computer 104.

The warehouse control system seller system 115 may comprise multiple computing devices, such as a server 116 and developer terminal 114. The developer terminal 114 and the server 116 may be connected to the Internet 110 and/or may be directly connected via a local network connection. In this manner, via the connections to the Internet 110 and/or the local network connection, the developer terminal 114 and server 116 may exchange data. Additionally, via the Internet 110, the developer terminal 114, server 116, user terminal 102, and/or warehouse control computer 104 may exchange data with one another. The developer terminal 114 may enable a warehouse control system seller to build new processes and sub-tasks, as well as process tables, for use by the warehouse control system 105. The developer terminal 114 may send indications of new process and sub-tasks to the server 116 and/or send new process tables to the server 116. Additionally, the developer terminal 114 may be enabled to set costs for new sub-tasks and/or processes. The server 116 may host a web portal (e.g., a website) enabling a user (for example, via user terminal 102) to select processes and/or sub-tasks and create new process tables. In response to the user's selections, the server 116 and/or the developer terminal 114 may generate a process table and send the process table to the user terminal 102 and/or warehouse control computer 104 of the warehouse control system 105.

Additionally, the network 100 may include one or more ordering terminals 112 connected to the Internet 110. As an example, the ordering terminal 112 may be a retailer computing device generating orders for inventory items stocked in the warehouse 103. Via their respective connections to the Internet 110, the ordering terminal 112 and user terminal 102 and/or warehouse control computer 104 of the warehouse control system 105 may exchange data. In operation, the ordering terminal 112 may send an order to the warehouse control computer 104 via the Internet 110. Upon receiving the order, the warehouse control computer 104 may select a process table downloaded from the server 116 and/or developer terminal 114. The warehouse control computer 104 may execute the sub-tasks within that selected process table to handle the order. These sub-tasks may include the control of the warehouse handling equipment 108, which may gather and ship the items on the order. Orders for inventory items stocked in the warehouse 103 received from the ordering terminals 112 may be only one example of assigned tasks that may be received at the warehouse control computer 104. Other assigned tasks, such as cycle counts, item moves, location/item replenishments, etc., may be generated by other devices and/or generated by the warehouse control computer 104 itself, and received at the warehouse control computer 104. Upon receiving an assigned task (e.g. a task generated by another device and/or the warehouse control computer 104 itself), the warehouse control computer 104 may select a process table downloaded from the server 116 and/or developer terminal 114. The warehouse control computer 104 may execute the sub-tasks within that selected process table to handle the received assigned task. These sub-tasks may include the control of the warehouse handling equipment 108, which may handle the items on the assigned task.

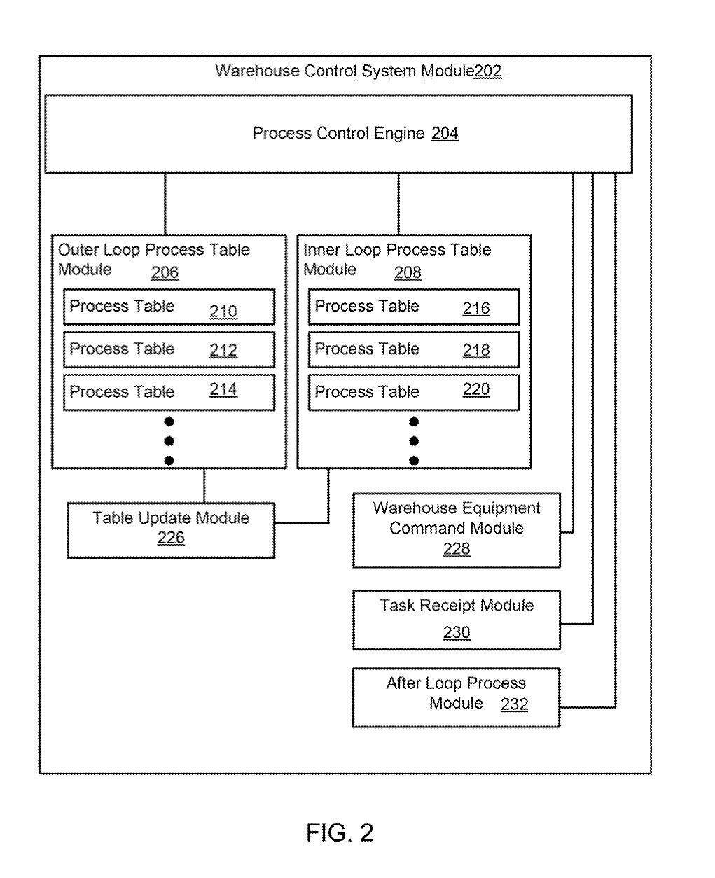

FIG. 2 is a block diagram of modules of an embodiment warehouse control system module 202. In an embodiment, a warehouse control system module 202 may run on a processor of a computing device of a warehouse control system. The warehouse control system module 202 may include a process control engine 204 which may be configured with control logic to select process tables and execute the sub-tasks within the process tables. The process control engine 204 may interface with an outer loop process table module 206, an inner loop process table module 208, an after loop process module 232, a warehouse equipment command module 228, and a task receipt module 230. The outer loop process table module 206 may include any number of process tables 210, 212, 214, etc. Each of the process tables 210, 212, 214, etc. may include a series of sub-tasks which may be executed by the process control engine 204 to handle orders as orders are received from the order receipt module 230. The inner loop process table module 208 may include any number of process tables 216, 218, 220, etc. Each of the process tables 216, 218, 220, etc. may include a series of sub-tasks which may be executed by the process control engine 204 to generate commands to output to the warehouse equipments command module. The generated commands may control one or more warehouse equipment system to handle items associated with a received assigned task, such as to ship items of received orders, count items of received cycle counts, move items or received item move requests, etc. The task receipt module 230 may receive an assigned task and provide the assigned task to the process control engine 204. The warehouse control equipment command module 228 may receive commands for warehouse control equipment from the process control engine 204 and send the commands to warehouse control equipment systems. The after loop process module 232 may include processes or sub-tasks that may be executed by the process control engine 204 upon completion of handling of a received assigned task prior to handling a next assigned task, such as processes or sub-tasks to display labor standards, processes or sub-tasks to display performance metrics, processes or sub-tasks to display associated staging locations, processes or sub-tasks to request user verification of successful sub-task execution (e.g., a request to verify palletization of items for shipment), etc. The table update module 226 may receive new process tables and/or updates to process tables and may send the new process tables and/or updates to process tables to the outer loop process table module 206 and/or the inner loop process table module 208, respectively.

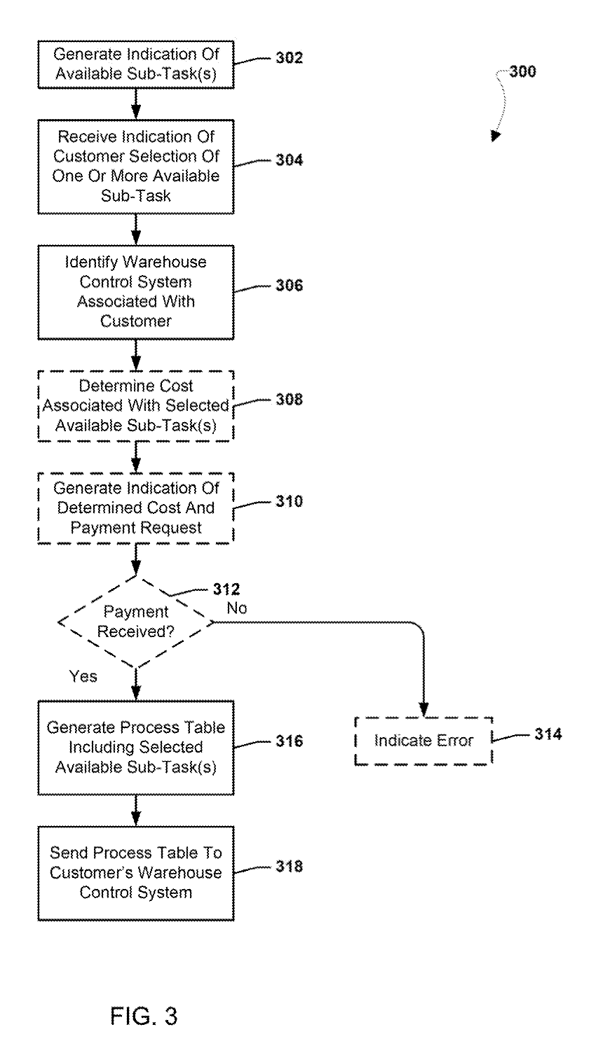

FIG. 3 illustrates an embodiment method 300 for customers to dynamically create and change automated process tables for use in a warehouse control system. In an embodiment, the operations of method 300 may be performed by a processor of a computing device of a seller of warehouse control systems, such as a processor of a server hosting a web portal indicating pre-built processes. In block 302 the processor may generate an indication of available sub-task(s). In an embodiment, the indication of available sub-task(s) may be a web based list enabling customers to select available sub-task(s). In block 304 the processor may receive an indication of a customer selection of one or more available sub-task. As an example, a customer selection of a sub-task may be an indication that the customer dragged and dropped sub-tasks from a list of available sub-tasks to a list of selected sub-tasks and subsequently selected an upload process button. In block 306 the processor may identify the warehouse control system associated with the customer. In optional block 308 the processor may determine a cost associated with the selected available sub-task(s). For example, each sub-task may have a fixed cost associated with it and the total number of selected sub-tasks may indicate the cost associated with the customer's selections. In option block 310 the processor may generate an indication of the determined cost and a payment request. As an example, the processor may generate a pop-up window indicating the cost and directing the customer to send a payment equal to the cost to the seller. In optional determination block 312 the processor may determine whether a payment is received. If payment is not received (i.e., determination block 312=“No”), in block 314 the processor may indicate an error. If payment is received (i.e., determination block 312=“Yes”), in block 316 the processor may generate a process table including the selected available sub-task(s). In block 318 the processor may send the process table to the customer's warehouse control system.

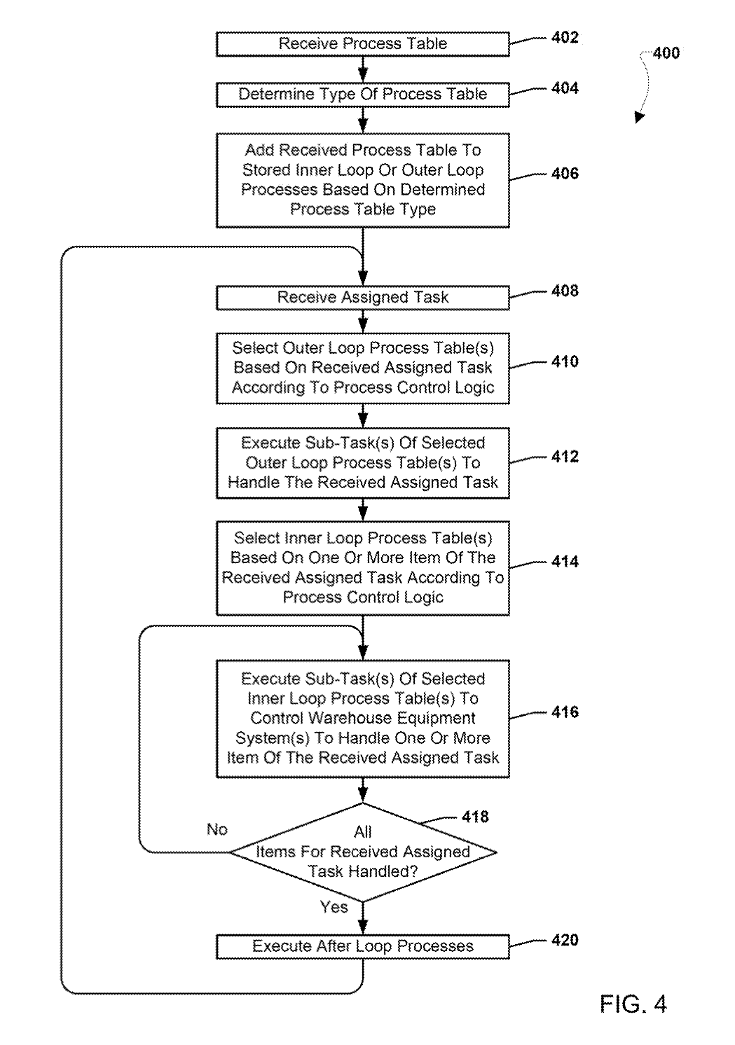

FIG. 4 illustrates an embodiment method 400 for processing assigned tasks using automated process tables and nested loops of process control logic. In an embodiment, the operations of method 400 may be performed by a processor of a computing device of a customer's warehouse control system, such as a processor of a warehouse control computer in communication with one or more warehouse equipment system. In an embodiment, the operations of method 400 may be performed in conjunction with the operations of method 300 described above with reference to FIG. 3.

In block 402 the processor may receive a process table. For example, the processor may receive a process table from a server of a warehouse control system seller. In block 404 the processor may determine a type of the process table. As an example, the process table may be an inner loop process table including sub-tasks to be executed to ship items of an order or may be an outer loop process table including sub-tasks to be executed to handle an order. In block 406 the processor may add the received process table to the stored inner loop or outer loop processes based on the determined process table type.

In block 408 the processor may receive an assigned task for one or more item. As examples, assigned tasks may be orders for one or more item, cycle counts for one or more item, item moves for one or more item, location/item replenishments for one or more item, etc. In block 410 the processor may select one or more outer loop process table based on the received assigned task according to process control logic. In block 412 the processor may execute sub-task(s) of the selected outer loop process table(s) to handle the received assigned task. For example, outer loop process tables may include sub-tasks such as a put away order, cycle counts, billing, etc. In block 414 the processor may select one or more inner loop process table based on one or more item of the received assigned task according to process control logic. In block 416 the processor may execute sub-task(s) of the selected inner loop process table(s) to control warehouse equipment system(s) to handle one or more item of the received assigned task. For example, inner loop process tables may include sub-tasks such as pick orders, ship to instructions, etc.

In determination block 418 the processor may determine whether all items for the received assigned task have been handled. As examples, the processor may determine whether all items for an order have shipped, all items for an item move have been moved, all items for a cycle count have been counted, all items for a replenishment have been re-ordered, etc. If all items have not been handled (i.e., determination block 418=“No”), in block 416 the processor may continue to execute sub-task(s) of the selected inner loop process table(s) to control warehouse equipment system(s) to handle one or more item of the received assigned task. In this manner, inner loop processes may be performed until all items are handled. If all items are handled (i.e., determination block 418=“Yes”), in block 420 the processor may execute after loop processes. After loop processes may be processes scheduled to be performed before handling a next assigned task, such as displaying labor standards, displaying performance metrics, displaying associated staging locations, requesting verification of successful sub-task execution (e.g., verifying palletization of items for shipment), etc. In an embodiment, the after loop processes to be performed may be based on the assigned task just completed and/or the after loop processes may be agnostic to the assigned task just completed. In block 408 the processor may receive the next assigned task and in block 410 select one or more outer loop process table based on the received next assigned task according to process control logic. In this manner, the processor may switch back to outer loop processes once an assigned task is handled to process the next assigned task, and the inner loop and outer loop processes may operate as nested loops to enable the processor to handle assigned task and the items in the assigned tasks by executing the sub-tasks of the respective process tables.

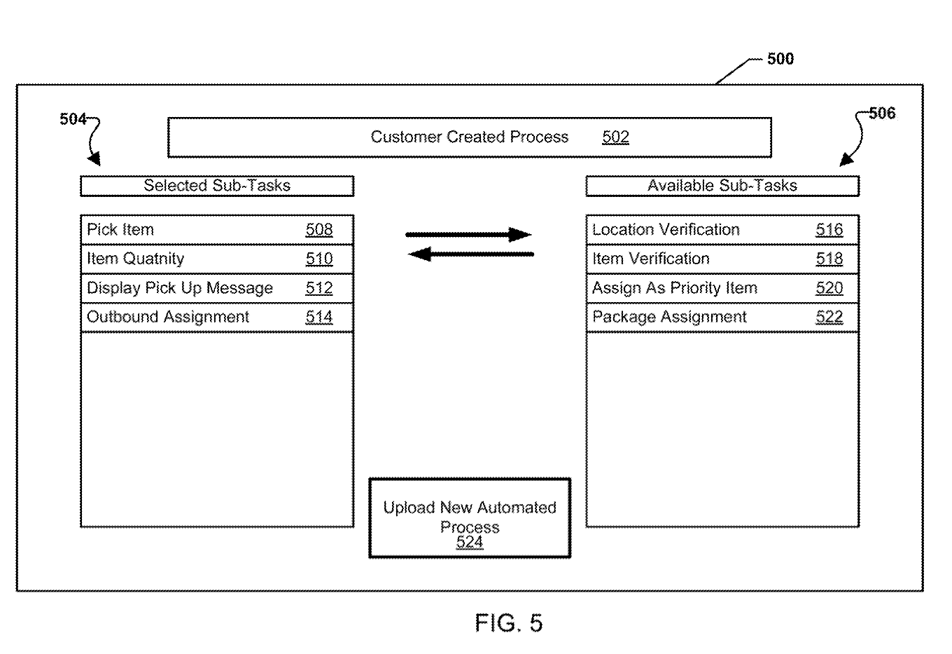

FIG. 5 illustrates an example screen shot of a portal 500 enabling customers to create automated processes. The portal 500 may be a web page including a banner 502 indicating a customer may create processes using the portal 500. A list of available sub-tasks 506 may be displayed on the right side of the portal 500. For example, available sub-tasks may include a location verification sub-task 516, an item verification sub-task 518, an assign as priority item sub-task 520, and package assignment sub-task 522. A list of selected sub-tasks 504 may be displayed on the left hand side of the portal 500. For example, selected sub-tasks may include a pick item sub-task 508, an item quantity sub-task 510, display pick up message sub-task 512, and outbound assignment sub-task 514. A customer may select an available sub-task from the list of available sub-tasks 506 and drag it into the list of selected sub-tasks 504. An upload new automated process button 524 may also be displayed, and when the customer clicks on the button 524 a new process comprised of the selected sub-tasks in the list of selected sub-tasks 504 may be generated and downloaded to the customer's warehouse control system.

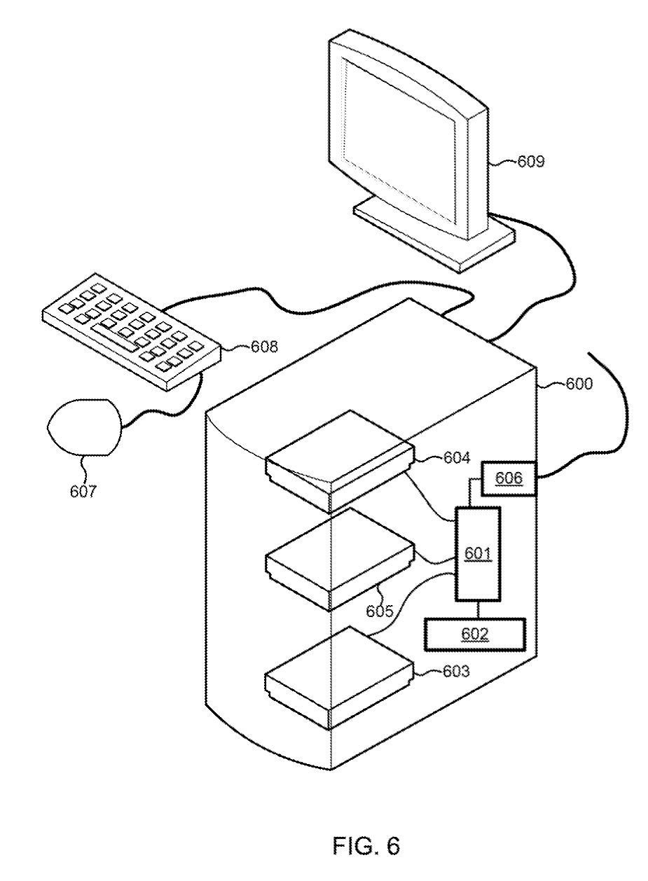

The various embodiments may be implemented in any of a variety of computing devices, an example of which is illustrated in FIG. 6. A computing device 600 will typically include a processor 601 coupled to volatile memory 602 and a large capacity nonvolatile memory, such as a disk drive 605 of Flash memory. The computing device 600 may also include a floppy disc drive 603 and a compact disc (CD) drive 604 coupled to the processor 804. The computing device 600 may also include a number of connector ports 606 coupled to the processor 601 for establishing data connections or receiving external memory devices, such as a USB or FireWire® connector sockets, or other network connection circuits for establishing network interface connections from the processor 601 to a network or bus, such as a local area network coupled to other computers and servers, the Internet, the public switched telephone network, and/or a cellular data network. The computing device 600 may also include the trackball 607, keyboard 608 and display 609 all coupled to the processor 601.

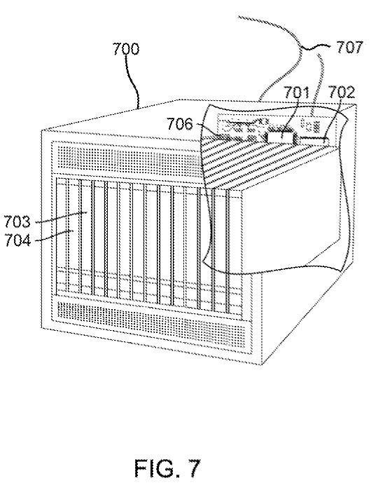

The various embodiments may also be implemented on any of a variety of commercially available server devices, such as the server 700 illustrated in FIG. 7. Such a server 700 typically includes a processor 701 coupled to volatile memory 702 and a large capacity nonvolatile memory, such as a disk drive 703. The server 700 may also include a floppy disc drive, compact disc (CD) or DVD disc drive 704 coupled to the processor 701. The server 700 may also include network access ports 706 coupled to the processor 701 for establishing network interface connections with a network 707, such as a local area network coupled to other computers and servers, the Internet, the public switched telephone network, and/or a cellular data network.

The processors 601 and 701 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory 602, 605, 702, and 703 before they are accessed and loaded into the processors 601 and 701. The processors 601 and 701 may include internal memory sufficient to store the application software instructions. In many devices the internal memory may be a volatile or nonvolatile memory, such as flash memory, or a mixture of both. For the purposes of this description, a general reference to memory refers to memory accessible by the processors 601 and 701 including internal memory or removable memory plugged into the device and memory within the processor 601 and 701 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method, comprising:
receiving, in a server, an indication of a user selection of one or more available sub-task;
identifying, in the server, a warehouse control system associated with the user;
generating, in the server, a process table including the selected one or more available sub-tasks; and
sending the process table to the identified warehouse control system from the server.

2. The method of claim 2, further comprising:
receiving the process table at the identified warehouse control system;
adding the received process table to a memory at the identified warehouse control system;
receiving an assigned task for one or more item at the identified warehouse control system;
selecting the received process table from the memory at the identified warehouse control system; and
executing, at the identified warehouse control system, the selected one or more available sub-tasks to control one or more warehouse equipment system to handle one or more item of the received assigned task.

3. The method of claim 2, further comprising:
determining, in the server, a cost associated with the selected one or more available sub-tasks;
generating, in the server, an indication of the determined cost and a payment request; and
determining, in the server, whether a payment associated with the payment request is received,
wherein generating, in the server, a process table including the selected one or more available sub-tasks comprises generating, in the server, a process table including the selected one or more available sub-tasks in response to determining the payment associated with the payment request is received.

4. The method of claim 2, wherein selecting the received process table from the memory at the identified warehouse control system is part of an inner or outer nested loop of process control logic.

5. The method of claim 2, wherein:
the assigned task for one or more item is an order; and
executing, at the identified warehouse control system, the selected one or more available sub-tasks to control one or more warehouse equipment system to handle one or more item of the received assigned task comprises executing, at the identified warehouse control system, the selected one or more available sub-tasks to control one or more warehouse equipment system to ship one or more item of the received order.

6. A system, comprising:
a server, comprising:
a first network interface; and
a server processor connected to the first network interface; and
a warehouse control system, comprising:
a second network interface;
a memory; and
a warehouse control system processor connected to the second network interface and the memory,
wherein the server processor is configured with processor executable instructions to perform operations comprising:
receiving an indication of a user selection of one or more available sub-task;
identifying the warehouse control system is associated with the user;
generating a process table including the selected one or more available sub-tasks; and
sending the process table to the warehouse control system via the first network interface.

7. The system of claim 6, wherein the warehouse control system processor is configured with processor executable instructions to perform operations comprising:
receiving the process table via the second network interface;
adding the received process table to the memory;
receiving an assigned task for one or more item via the second network interface;
selecting the received process table from the memory; and
executing the selected one or more available sub-tasks to control one or more warehouse equipment system to handle one or more item of the received assigned task.

8. The system of claim 7, wherein the server processor is configured with processor executable instructions to perform operations further comprising:
determining a cost associated with the selected one or more available sub-tasks;
generating an indication of the determined cost and a payment request; and
determining whether a payment associated with the payment request is received, and
wherein the server processor is configured with processor executable instructions to perform operations such that generating a process table including the selected one or more available sub-tasks comprises generating a process table including the selected one or more available sub-tasks in response to determining the payment associated with the payment request is received.

9. The system of claim 7, wherein the warehouse control system processor is configured with processor executable instructions to perform operations such that selecting the received process table from the memory is part of an inner or outer nested loop of process control logic.

10. The system of claim 7, wherein the warehouse control system processor is configured with processor executable instructions to perform operations such that:
the assigned task for one or more item is an order; and
executing the selected one or more available sub-tasks to control one or more warehouse equipment system to handle one or more item of the received assigned task comprises executing the selected one or more available sub-tasks to control one or more warehouse equipment system to ship one or more item of the received order.

11. A warehouse control system, comprising:
a memory; and
a warehouse control system processor connected to the memory, wherein warehouse control system processor is configured with processor executable instructions to perform operations comprising:
receiving a process table, wherein the process table includes one or more user selected available sub-tasks; and
adding the received process table to the memory;
receiving an assigned task for one or more item via a network interface;
selecting the received process table from the memory; and
executing the one or more customer selected available sub-tasks to control one or more warehouse equipment system to handle one or more item of the received assigned task.

12. The warehouse control system of claim 11, wherein the warehouse control system processor is configured with processor executable instructions to perform operations such that selecting the received process table from the memory is part of an inner or outer nested loop of process control logic.

13. The system of claim 11, wherein the warehouse control system processor is configured with processor executable instructions to perform operations such that:
the assigned task for one or more item is an order; and
executing the selected one or more available sub-tasks to control one or more warehouse equipment system to handle one or more item of the received assigned task comprises executing the selected one or more available sub-tasks to control one or more warehouse equipment system to ship one or more item of the received order.

14. A non-transitory processor readable storage medium having stored thereon process-executable instructions configured to cause a processor of a warehouse control system to perform operations comprising:
receiving a process table, wherein the process table includes one or more user selected available sub-tasks; and
adding the received process table to a memory of a warehouse control system;
receiving an assigned task for one or more item via a network interface;
selecting the received process table from the memory of a warehouse control system; and
executing the one or more user selected available sub-tasks to control one or more warehouse equipment system to handle one or more item of the received assigned task.

15. The non-transitory processor readable storage medium of claim 14, wherein the stored processor-executable instructions are configured to cause a processor of a warehouse control computer to perform operations such that selecting the received process table from the memory is part of an inner or outer nested loop of process control logic.

16. The non-transitory processor readable storage medium of claim 14, wherein the stored processor-executable instructions are configured to cause a processor of a warehouse control computer to perform operations such that:
the assigned task for one or more item is an order; and
executing the selected one or more available sub-tasks to control one or more warehouse equipment system to handle one or more item of the received assigned task comprises executing the selected one or more available sub-tasks to control one or more warehouse equipment system to ship one or more item of the received order.
